(19) United States
(12) Patent Application Publication
(10) Pub. No.: US 2017/0307828 A1
(43) Pub. Date: Oct. 26, 2017

(54) HYBRID ELECTRICAL OPTICAL CONNECTOR WITH SPRING-LOADED ELECTRICAL CONTACTS AT A CONTACT FACE

(71) Applicant: CommScope Asia Holdings B.V., Bussum (NL)

(72) Inventor: Jacob Arie ELENBAAS, Heijningen (NL)

(21) Appl. No.: 15/532,424

(22) PCT Filed: Dec. 1, 2015
(86) PCT No.: PCT/EP2015/078234

§ 371 Date: Jun. 1, 2017

Related U.S. Application Data
(60) Provisional application No. 62/086,021, filed on Dec. 1, 2014.

(51) Int. Cl. G02B 6/38; H01R 13/08

(52) U.S. Cl. CPC G02B 6/3817; H01R 13/08; G02B 6/3882; G02B 6/3885

(57) ABSTRACT

A hybrid fiber optic/electrical connector including a connector body (111) having a front end (112) and a back end (113); a ferrule (510) mounted at the front end of the connector body, the ferrule including a depth that extends from a front end (171) to a rear end (173) of the ferrule; a spring (129) for biasing the ferrule (510) in a forward direction relative to the connector body (111); a plurality of optical fibers (175) supported by the ferrule (510), the optical fibers having end faces (106) accessible at the front end (171) of the ferrule; and electrical conductors (179) supported by the ferrule (510), the electrical conductors including spring-loaded contacts (163) accessible at the front end (171) of the ferrule.

### CROSS-REFERENCE TO RELATED APPLICATION

This application claims the benefit of U.S. Patent Application Ser. No. 62/086,021, filed on Dec. 1, 2014, the disclosure of which is incorporated herein by reference in its entirety.

### TECHNICAL FIELD

The present disclosure relates generally to optical fiber communication systems. More particularly, the present disclosure relates to fiber optic connectors used in optical fiber communication systems.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respected optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

A number of hybrid electrical/optical connectors having electrical conductor contacts and optical transmission fibers exist. Hybrid electrical/optical connectors are connectors that transmit information through the optical fibers and transmit power or electrical signals through the electrical conductors. Example hybrid electrical/optical connectors are disclosed in U.S. Pat. Nos. 6,599,025 and 7,785,019. Improvements are needed in the area of hybrid electrical/optical connectors.

### SUMMARY

One aspect of the present disclosure relates to a hybrid multi-fiber connector that includes a connector body and a ferrule with both optical fibers and spring-loaded electrical contacts accessible at the front contact face of the ferrule. The connector body has a front end and a back end, and the ferrule is spring-biased toward the front end of the connector body. Aspects of this connector combine electrical and optical connection locations in one location (e.g., on the same ferrule) thereby enhancing use of space, facilitating making electrical and optical connections and simplifying cable routing. Aspects of the connector also allow for enhanced circuit density and space usage at structures such as closures, panels and cabinets. Aspects of the connector design also provide a small form-factor connector that accommodates multiple optical fibers and also provides electrical power connectivity. Aspects of the present disclosure also enhance shielding effectiveness and ingress protection when used with closures.

Another aspect of the present invention relates to a ferrule that has a rear end and a front contact face. The ferrule includes a plurality of optical fibers that extend from the front contact face to the rear end. Ends of the optical fibers are positioned along the front contact face. The ferrule also includes a pair of spring-loaded electrical contacts that are accessed from the front contact face. The pair of spring-loaded electrical contacts are positioned on either side of the plurality of optical fibers.

A still further aspect of the present invention is a ferrule that includes a plurality of optical fiber passages through which a plurality of optical fibers extend. The ferrule also includes a plurality of conductor passages through which electrical conductors extend. In one example, the electrical conductors are adapted for transmitting electrical power and include a first electrical conductor connected to ground and a second electrical conductor connected to a source of electrical power.

### BRIEF DESCRIPTION OF THE DRAWINGS

FIG. 1 is a perspective view of a first example hardened multi-fiber cable assembly in accordance with the principles of the present disclosure, an adapter is shown coupling the first cable assembly to a second example cable assembly terminated by a multi-fiber connector;

FIG. 2 is an exploded view of the assembly of FIG. 1, including an example connector that has a connector body, a spring-biased multi-fiber ferrule, and a cover;

FIG. 3 is a top plan view of the example connector of FIG. 2;

FIG. 4 is a perspective view of the example connector of FIG. 2, shown in the cover exploded from a side opening in the connector body;

FIG. 5 is an isolated perspective view of the multi-fiber ferrule of FIG. 2, rotated 90°;

FIG. 6 is a front plan view of the multi-fiber ferrule of FIG. 5, viewed along sight-line Z;

FIG. 7 is a top cross-sectional view of the multi-fiber ferrule of FIG. 5, viewed along sight-line Y.

FIG. 8 is a top cross-sectional view of the multi-fiber ferrule of FIG. 5, viewed along sight-line Y, shown in optical and electrical communication with a mating multi-fiber ferrule.

### DETAILED DESCRIPTION

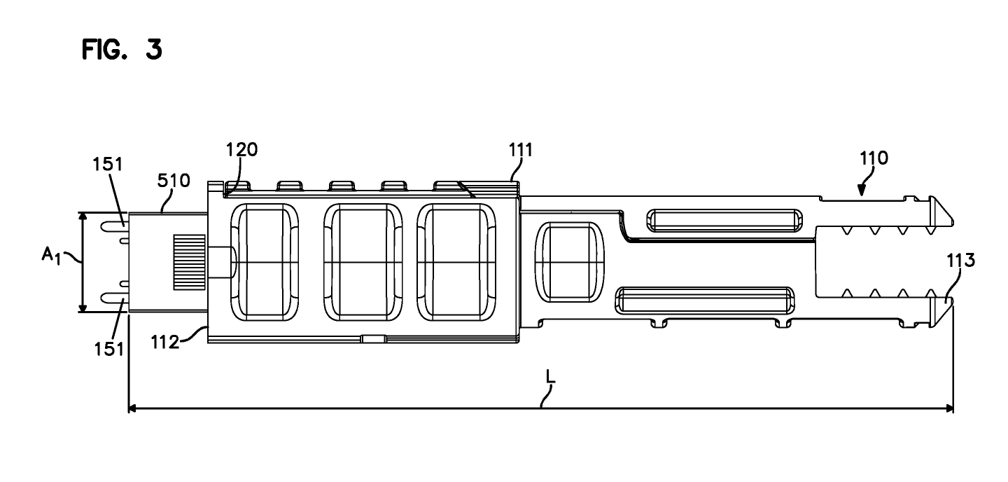

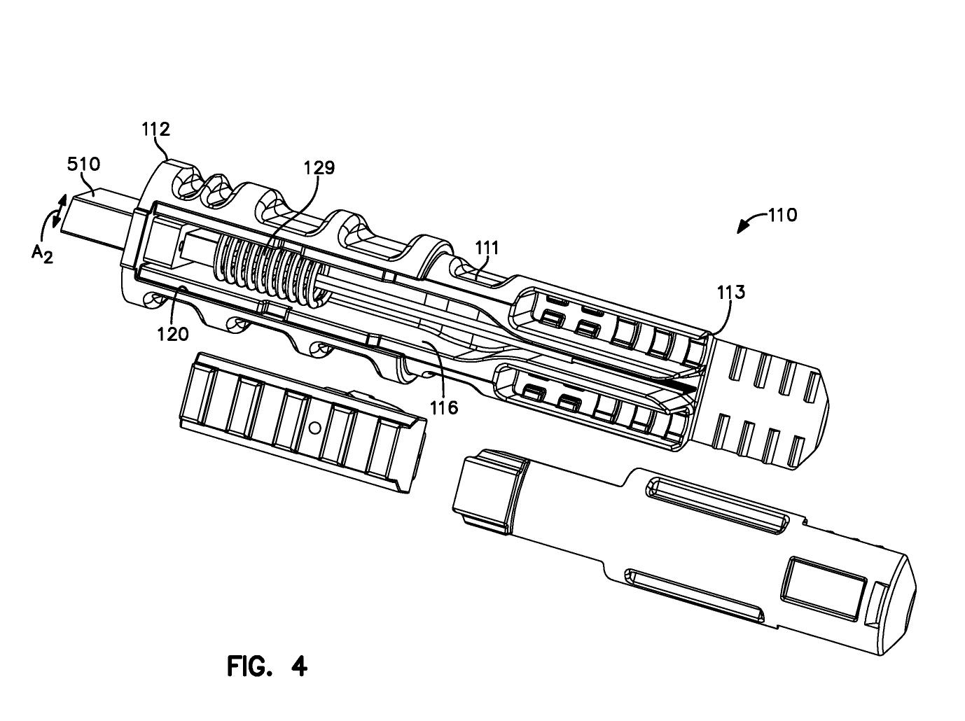

Some aspects of this disclosure are directed to certain types of hybrid fiber optic/electrical connectors for use with fiber optic cable assemblies, for example as described in U.S. patent application Ser. No. 14/360,383, the disclosure of which is hereby incorporated herein by reference. In accordance with some implementations, for example as shown in FIGS. 3 and 4, the hybrid fiber optical/electrical connector 110 may include a connector body 111 that has a front end 112 and a back end 113. In the depicted example, the hybrid fiber optical/electrical connector may include a ferrule 510 mounted at the front end 112 of the connector body 111. The connector body 111 has a length L that extends along an axis of the connector body 111. The multi-fiber ferrule 510 is configured to receive polished ends of multiple optical fiber portions.

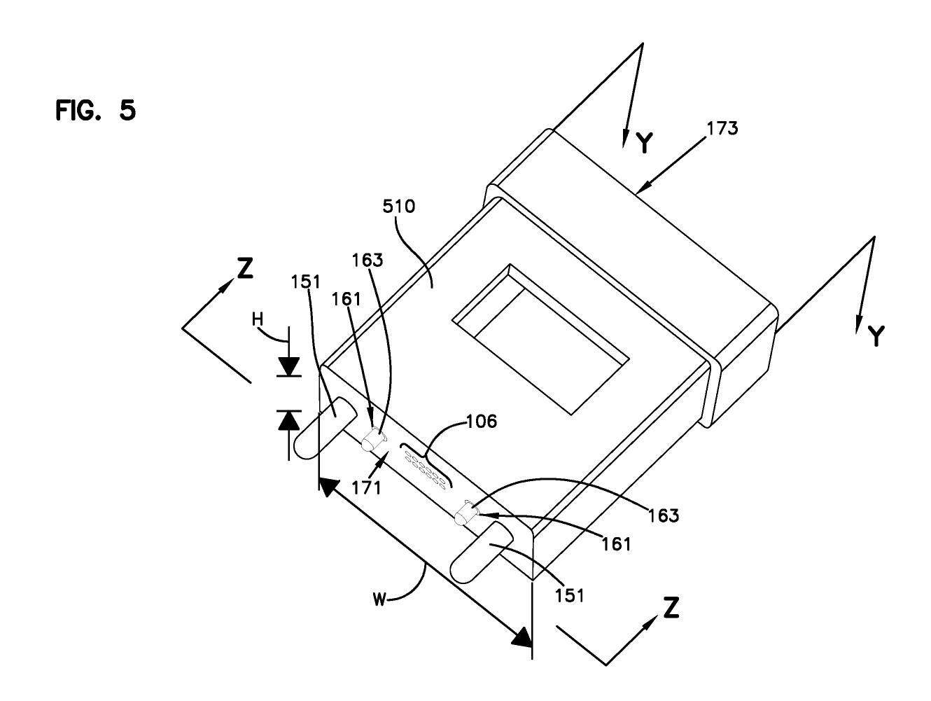

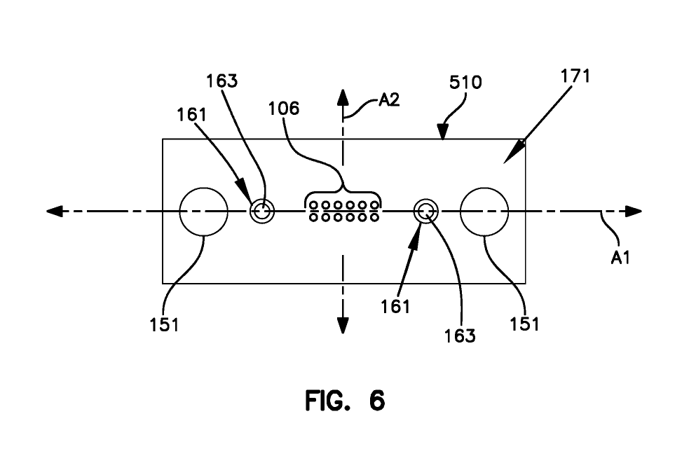

In some implementations, for example as shown in FIGS. 5-7, the ferrule 510 may include a depth that extends from a front end 171 to a rear end 173 of the ferrule. In the depicted example, the ferrule 510 may include a contact face at the front end 171 of the ferrule. As depicted, the contact face at the front end 171 may include a major dimension that extends along a major axis A₁ defined by the contact face and a minor dimension that extends along a minor axis A₂ defined by the contact face. The major A₁ and minor A₂ axes may be perpendicular to one another. As depicted in the examples shown in FIGS. 5 and 6, the ferrule 510 may have a contact face that is rectangle shaped. However, it is contemplated that alternative shapes can be effective, for example oblong, obround, etc.

In some implementations, for example as shown in FIGS. 5-7, the ferrule 510 may include fiber passages 169 that extend through the depth of the ferrule from the rear end 173 of the ferrule to the front end 171 of the ferrule. Example fiber passages 169 may include elongated openings arranged in parallel. Example fiber passages 169 may be arranged in a row that extends along the major axis A₁ of the contact face. As depicted in the example shown in FIGS. 5 and 6, the fiber passages 169 may be arranged in two parallel rows that extend along the major axis A₁ of the contact face. In the depicted example, the ferrule 510 may include a plurality of fiber passages 169, for example between two and twenty, and more preferably between six and twelve.

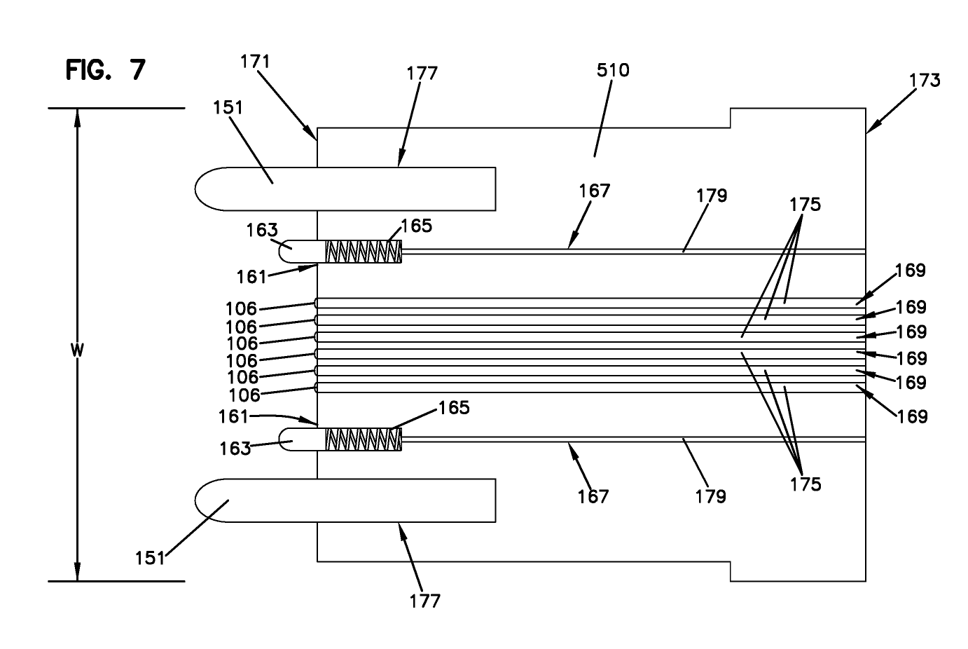

In some implementations, for example as shown in FIG. 7, the hybrid fiber optical/electrical connector may include a plurality of optical fibers 175 that extend through the fiber passages 169 of the ferrule 510. Example optical fibers 175 include fibers that are capable of carrying or transmitting an optical communication signal. As depicted in FIGS. 5-7, the optical fibers 175 may have end faces 106 that are accessible at the front end of the ferrule 510. Example end faces 106 are capable of communicating with another ferrule when aligned face-to-face.

In some implementations, for example as shown in FIG. 7, the ferrule 510 may include conductor passages 167 that extend through the depth of the ferrule from the rear end 173 of the ferrule to the front end 171 of the ferrule. Example conductor passages 167 may include elongated openings arranged in parallel. In the depicted example, conductor passages 169 may be arranged in parallel along the major axis A₁ of the contact face. In the depicted example, the conductor passages 167 may include contact mounting receptacles 161 at the front end of the ferrule 510.

In some implementations, for example as shown in FIG. 7, the hybrid fiber optical/electrical connector may include electrical conductors 179 that extend through the conductor passages 167 of the ferrule 510. Example electrical conductors 179 may include elongated wires that are capable of carrying or transmitting electrical power. The example conductors 179 can carry of transmit electric current and a voltage potential can be provided between the conductors. In certain examples, the conductors can be rated to handle electrical power in the range of 15-50 Watts, or less than 100 Watts. In one example, the conductors can have an Ampere rating of about 1 Amp. Of course, cables capable of carrying other power levels, current ratings and voltages are also contemplated.

In other examples, the electrical conductors can carry electrical signals. In some implementations, the electrical conductors 179 may include spring-loaded contacts 163 that are mounted with springs 165 at or in the contact mounting receptacles 161 of the ferrule 510. In the depicted example, the spring-loaded contacts 163 may have contact portions that are accessible at the front end of the ferrule 510. In the depicted example, the spring loaded contacts 163 may include spring loaded pins, and the contact portions of the spring-loaded pins may include the ends of the pins. In the depicted example, the ends of the spring-loaded contacts 163 may be rounded. The spring-loaded contacts 163 can be provided by spring probe connectors mounted within receptacles (i.e., holes, pockets, openings) defined by the ferrule.

In some implementations, for example as shown in FIG. 7, the electrical conductors 167 may include first and second electrical conductors 179. The example depicted optical fibers 175 may be positioned between the first and second electrical conductors. In the depicted example, the optical fibers 175 and the first and second electrical conductors 179 may be aligned along the major axis A₁ of the contact face of the ferrule 510.

In some implementations, for example as shown in FIG. 4, the connector body 111 also defines a side opening 120 that extends along at least part of the length L of the connector body 111. The side opening 120 is arranged and configured to allow the multi-fiber ferrule 510 to be inserted laterally into the connector body 111 through the side opening 120. In certain implementations, the side opening 120 is arranged and configured to allow the multi-fiber ferrule 510 and the optical fibers 175 to be inserted laterally into the connector body 111 through the side opening 120. In this way, the optical fibers 175 need not be axially threaded through an opening during the loading process. In some implementations, the side opening 120 extends along the length L of the connector body 111 for at least fifty percent of the length L of the connector body 111. Indeed, in some implementations, the side opening 120 extends along the length L of the connector body 111 for at least 75 percent of the length L of the connector body 111.

In some implementations, for example as shown in FIG. 4, the hybrid fiber optical/electrical connector may include a spring 129 (e.g., a coil spring) disposed in the connector interior 116 for biasing the ferrule 510 in a forward direction through the first end 112 of the connector body 111. In example embodiments, the spring force of the electrical conductor springs 165 are less than the spring force of the connector spring 129, thus preventing the electrical conductor springs from interfering with face-to-face contact between the end faces of mating ferrules.

In some implementations, for example as shown in FIGS. 5-7, the hybrid fiber optical/electrical connector may include alignment structures for aligning ferrules that are desired to be coupled together. In the depicted example, the alignment structures may include strength components, for example alignment openings 177 or alignment pins 151 that are integrated with the ferrule 510. In the depicted example, the optical fibers 175 and the electrical conductors 179 may be positioned between the alignment structures. In the depicted example, the optical fibers 175, the electrical conductors 170 and the alignment structures may be aligned along the major axis A₁ of the contact face.

In some implementations, each strength components 151 may be formed by a layer of reinforcing elements (e.g., fibers or yarns such as aramid fibers or yarns) embedded or otherwise integrated within a binder to form a reinforcing structure. In still other implementations, each strength component 151 can have a glass reinforced polymer (GRP) construction. In some implementations, the strength component 151 has a round cross-sectional profile. In other implementations, the cross-sectional profile of the strength component 151 may be any desired shape (e.g., rectangular, oblong, obround, etc.). Other example cable configurations are disclosed in U.S. Pat. No. 8,041,166, the disclosure of which is hereby incorporated herein by reference.

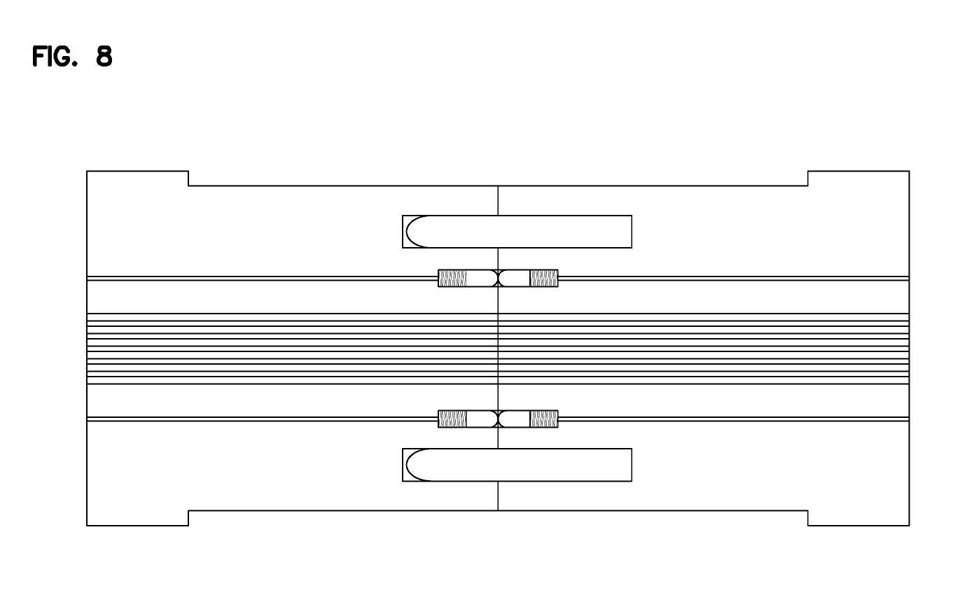

As particularly shown in FIG. 8, the depicted ferrule 510 may optically and electrically communicate with a mating ferrule. As depicted, the mating ferrules 510 may have common structures and elements, with the only exception being that one includes alignment pins 510 and the other includes alignment openings. As depicted, when mated, the alignment pins 151 of one ferrule 510 inserts into the alignment opening 177 of the mating ferrule. As depicted, the optical fiber end faces 106 of one ferrule 510 align with and touch the optical fiber end faces of the mating ferrule. As depicted, the spring-loaded contacts 163 of one ferrule 510 align with and touch the spring-loaded contacts of the mating ferrule. When in contact as depicted, each spring-loaded contact 163 forces the mating spring-loaded contact within the respective contact mounting receptacle 161 by compressing the respective electrical conductor spring 165.

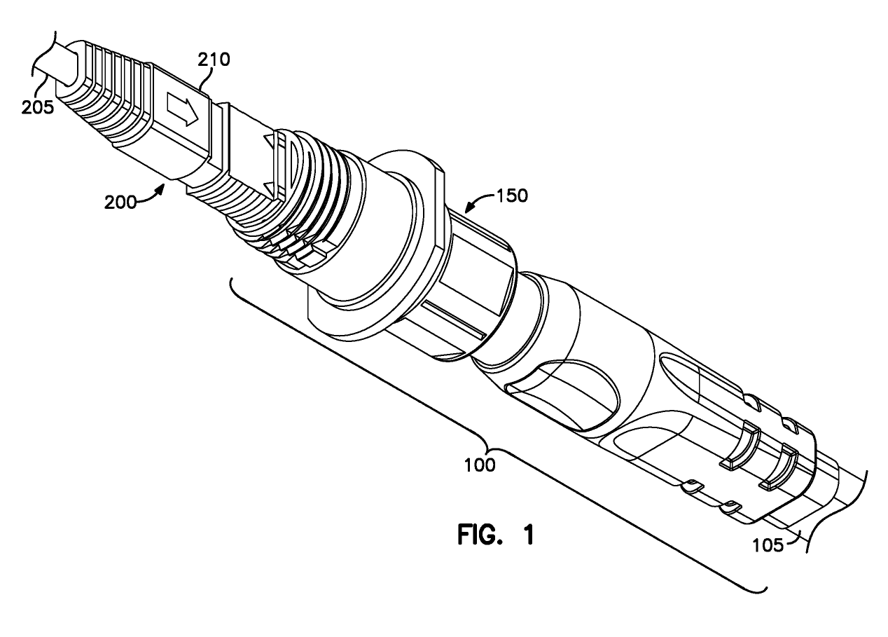

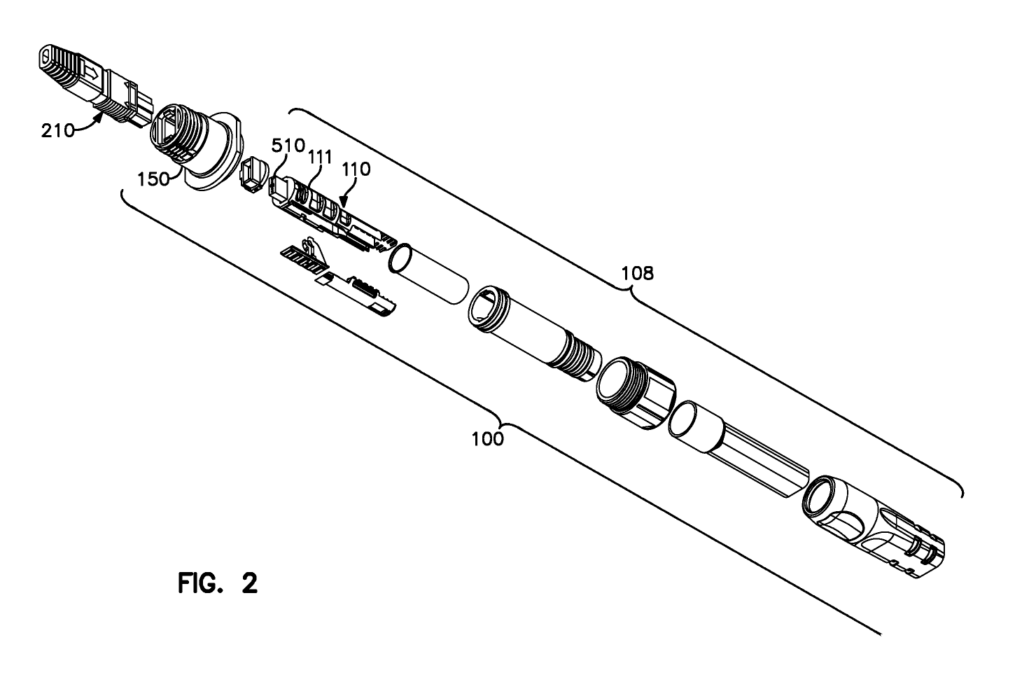

Other aspects of this disclosure, for example as shown in FIGS. 1 and 2, are directed to fiber optic cable assemblies 100 including a fiber optic cable 105 terminated by the fiber optic connector 110. In accordance with some aspects, the fiber optic connector 110 may be part of a hardened (i.e., environmentally sealed) fiber optic connector arrangement 108. In some implementations, the fiber optic connector arrangement 108 is configured to interface with a second fiber optic cable assembly 200. In the depicted example, the second fiber optic cable assembly 200 includes a multi-fiber connector 210 similar to that described above, terminating a second fiber optic cable 205.

In other implementations, for example as shown in FIGS. 1 and 2, the fiber optic connector arrangement 108 is configured to couple to a fiber optic adapter 150 to enable connection to the fiber optic connector 210 of the second fiber optic cable assembly 200. For example, the example adapter 150 enables the first fiber optic connector 110, which terminates a first optical cable 105, to mate with a second optic connector 210, which terminates a second optical cable 205. The adapter 150 defines a socket configured to receive a connectorized end of the second cable assembly 200. In some implementations, the fiber optic adapter 150 is configured to mount within an opening defined in a wall, plate, enclosure, or other structure.

From the forgoing detailed description, it will be evident that modifications and variations can be made without departing from the spirit and scope of the disclosure.

### PARTS LIST

100—Fiber optic cable assembly
105—Fiber optic cable
106—Optical fiber end face
108—Fiber optic connector arrangement
110—Fiber optic connector
111—Fiber optic connector body
112—Fiber optic connector body front end
113—Fiber optic connector body rear end
116—Fiber optic connector body interior
120—Fiber optic connector body side opening
129—Connector spring
150—Fiber optic adapter
151—Alignment pin
161—Contact mounting receptacle
163—Spring-loaded contact
165—Electrical conductor spring
167—Electrical conductor passage
169—Optical fiber passage
171—Ferrule front end
173—Ferrule rear end
175—Optical fiber
177—Alignment opening
179—Electrical conductor
200—Second fiber optic cable assembly
205—Second fiber optic cable
210—Second fiber optic connector
510—Multi-fiber ferrule

1. A hybrid fiber optic/electrical connector comprising:
a connector body having a front end and a back end ;
a ferrule mounted at the front end of the connector body, the ferrule including a depth that extends from a front end to a rear end of the ferrule, the ferrule including a contact face at the front end of the ferrule, the contact face including a major dimension that extends along a major axis defined by the contact face and a minor dimension that extends along a minor axis defined by the contact face, the major and minor axes being perpendicular to one another, the ferrule defining fiber passages that extend through the depth of the ferrule from the rear end of the ferrule to the front end of the ferrule, the fiber passages being arranged in a row that extends along the major axis of the contact face, the ferrule also defining conductor passages that extend through the depth of the ferrule form the rear end of the ferrule to the front end of the ferrule, the conductor passages including contact mounting receptacles at the front end of the ferrule;
a spring for biasing the ferrule in a forward direction relative to the connector body;
a plurality of optical fibers that extend through the fiber passages of the ferrule, the optical fibers having end faces accessible at the front end of the ferrule; and
electrical conductors that extend through the conductor passages of the ferrule, the electrical conductors including spring-loaded contacts mounted at the contact mounting receptacles of the ferrule, the spring-loaded contacts having contact portions accessible at the front end of the ferrule.

2. The hybrid fiber optic/electrical connector of claim 1, wherein the spring loaded contacts include spring loaded pins, and wherein the contact portions of the spring-loaded pins include ends of the pins.

3. The hybrid fiber optic/electrical connector of claim 2, wherein the ends of the spring-loaded pins are rounded.

4. The hybrid fiber optic/electrical connector of claim 1, further comprising alignment structures for aligning ferrules desired to be coupled together, the alignment structures including alignment openings or alignment pins integrated with the ferrule.

5. The hybrid fiber optic/electrical connector of claim 4, wherein the optical fiber and the electrical conductors are positioned between the alignment structures.

6. The hybrid fiber optic/electrical connector of claim 5, wherein the optical fibers, the electrical conductors and the alignment structures are aligned along the major axis of the contact face.

7. The hybrid fiber optic/electrical connector of claim 1, wherein the electrical conductors include first and second electrical conductors, and wherein the optical fibers are positioned between the first and second electrical conductors.

8. The hybrid fiber optic/electrical connector of claim 7, wherein the optical fiber and the first and second electrical conductors are aligned along the major access of the contact face of the ferrule.

9. A hybrid fiber optic/electrical connector comprising:
a connector body having a front end and a back end;
a ferrule mounted at the front end of the connector body, the ferrule including a depth that extends from a front end to a rear end of the ferrule,
a spring for biasing the ferrule in a forward direction relative to the connector body;
a plurality of optical fibers supported by the ferrule the optical fibers having end faces accessible at the front end of the ferrule; and
electrical conductors supported by the ferrule, the electrical conductors including spring-loaded contacts accessible at the front end of the ferrule.
